(19) United States
(12) Patent Application Publication
(10) Pub. No.: US 2008/0283762 A1
(43) Pub. Date: Nov. 20, 2008

(54) Radiation detector employing amorphous material

(75) Inventors: Eric M. Weissman, Chagrin Falls, OH (US); Thomas R. Anderson, Perry, OH (US); Lucas L. Clarke, Brussels (BE); Luana E. Iorio, Clifton Park, NY (US); Francis Johnson, Clifton Park, NY (US); Nathan H. Johnson, Garfield Heights, OH (US); Greggor T. Nallo, Twinsburg, OH (US); James R. Williams, University Heights, OH (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/803,262

(22) Filed: May 14, 2007

(51) Int. Cl. H01J 47/12

(52) U.S. Cl. 250/374

(57) ABSTRACT

A radiation detector is provided having an anode wire formed of an amorphous metal alloy. In one embodiment the radiation detector comprises a cathode assembly. The cathode assembly includes a main portion, a first end and a second end, where the first end opposes the second end. The cathode assembly also includes a radiation interacting material. An anode extends within the cathode assembly from the first end to the second end, and the anode is comprised of an amorphous metal alloy.

### BACKGROUND OF THE INVENTION

This invention relates generally to radiation detectors. In particular, the invention relates to the use of amorphous material for the anode wires of radiation detectors.

Radiation detectors, such as proportional radiation counters and/or neutron detectors, are often used in oil, gas and mineral exploration (e.g., downhole applications), in connection with nuclear reactors and industrial gauging, scientific research (e.g., neutron scattering research), and in homeland security applications to detect radioactive material or “dirty bombs”.

One type of radiation detector is a proportional counter, and this type of detector is often used for neutron detection. A typical proportional counter includes a substantially cylindrical cathode tube, and an anode wire that extends through the cathode tube. The anode wire typically is very thin (e.g., 5-25 microns, or more in diameter) and has substantial electrical resistance. The cathode tube is sealed at both ends, and may be filled with a gas, such as Helium-3 (³He) or BF₃ gas. The anode wire is insulated from the cathode and is typically maintained at a positive voltage while the cathode is at ground (or negative voltage).

During use, incident radiation, such as neutrons, interacts with the gas inside the cathode and produces charged particles that ionize the gas atoms and produce electrons. The electrons are drawn to and strike the positive anode wire and create a current pulse that can be detected. This occurrence can also be referred to as an incident radiation event. The magnitude of the current pulse is proportional to the energy liberated in the ionization event (i.e., a neutron interacting with ionizable gas).

In some applications proportional counters can be used as position sensitive detectors in which the locations of the arriving ionized electrons are determined from either the difference in the rise times of current pulses at opposite ends of the anode wire or from the relative amounts of charge reaching the ends (e.g., the charge division method). The spatial resolution of the position sensitive detector is enhanced by increasing the electrical resistance of the anode wire, which slows down the current pulses, increasing the time for the control electronics to detect the current pulses. Accordingly, high resistance anode wires are preferred to improve the spatial resolution of position sensitive detectors.

Radiation detectors, proportional radiation counters and neutron detectors are often used in harsh environments. The detectors can be exposed to extreme low and high temperatures, to low or high frequency vibrations and to corrosive environments. Designing a very thin anode wire to survive in these environments can be a challenge. The anode wire preferably should have high electrical resistivity (for good spatial resolution), a smooth surface finish and uniform thickness (for uniform resistance over it's length and uniform gas gain or amplification), corrosion resistance (for harsh environments), and high tensile strength (to eliminate deleterious effects due to unwanted vibrations).

The anode wire is placed under tension during assembly of the radiation detector, and the wire must survive the manufacturing process as well as thermal and mechanical stress imparted during service. Crystalline metal alloys have been used as anode wires, and have low tensile strength and plastically deform once their tensile strength is exceeded. The failure of the anode wire and/or a change in its dimensions due to plastic deformation degrades the operation of the radiation detector. Additionally, when the radiation detector is used in some applications, it is desirable to render the radiation detector insensitive to low frequency vibrations. Typically, this is achieved by placing the anode wire under high mechanical tension. Unfortunately, crystalline metal alloys can plastically deform and/or break, and experience a high failure rate and a short service life. Accordingly, a need exists in the art for an anode wire that has high electrical resistivity, a smooth surface finish, good corrosion resistance and high tensile strength.

### BRIEF DESCRIPTION OF THE INVENTION

In one aspect of the present invention, a radiation detector is provided having a cathode and an anode. The anode is comprised of an amorphous metal alloy.

In another aspect of the present invention, a radiation detector is provided having a cathode assembly. The cathode assembly comprises a main portion, a first end and a second end. The first end opposes the second end. The cathode assembly defines a volume, and a radiation interacting material is contained within this volume. An anode extends within the cathode assembly from the first end to the second end. The anode is comprised of an amorphous metal alloy.

### BRIEF DESCRIPTION OF THE DRAWINGS

FIG. 1 is a simplified schematic illustration of a gas-filled radiation detector.

FIG. 2 is a block diagram illustration of a radiation detector according to one embodiment of the present invention.

### DETAILED DESCRIPTION OF THE INVENTION

Radiation detectors can comprise many different types of detectors. A proportional counter is one example of a radiation detector that can be used for neutron detection. Radiation detectors come in many varieties, such as, sealed tube counters, windowless flow counters, pancake detectors, single wire detectors, multi-wire detectors, gas electron multiplier detectors, parallel plate avalanche counters, position sensitive proportional counters, and gas proportional scintillation counters, to name a few. Radiation detectors are often substantially cylindrical in cross-section, but they can also be elliptical, near elliptical, and rectangular in cross section. Radiation detectors can be used to detect many types of radiation, including but not limited to, charged particulate radiation (e.g., fast electrons, beta particles, heavy charged particles, alpha particles, or protons) and/or uncharged particles (e.g., electromagnetic radiation or neutrons). Hereinafter, the term radiation detector, will be understood to encompass all devices that can be used to detect radiation, including neutron detectors.

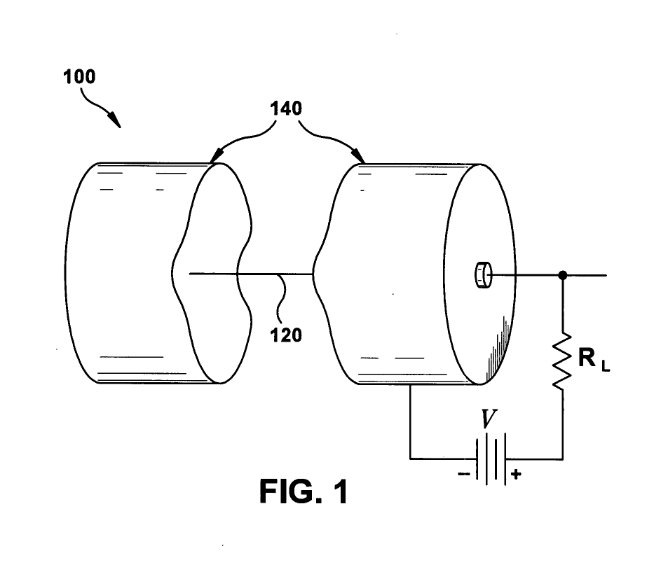

FIG. 1 is a simplified schematic of a gas-filled proportional radiation detector 100 with an amorphous metal anode wire 120 and a cathode 140, as embodied by one aspect of the present invention. The amorphous metal anode wire 120 can be obtained from a glass-coated microwire by removing the glass coating. Generally, the anode wire 120 is held at a positive potential, and the cathode 140 is held at negative potential or ground. The positive potential of anode wire 120 draws electrons to the anode 140, so that an incident radiation event may be detected. For the circuit shown in FIG. 1, an output pulse is developed across load resistance R_{L}.

The output pulse can be detected with suitable circuitry (not shown in FIG. 1), to determine when an incident radiation event has occurred.

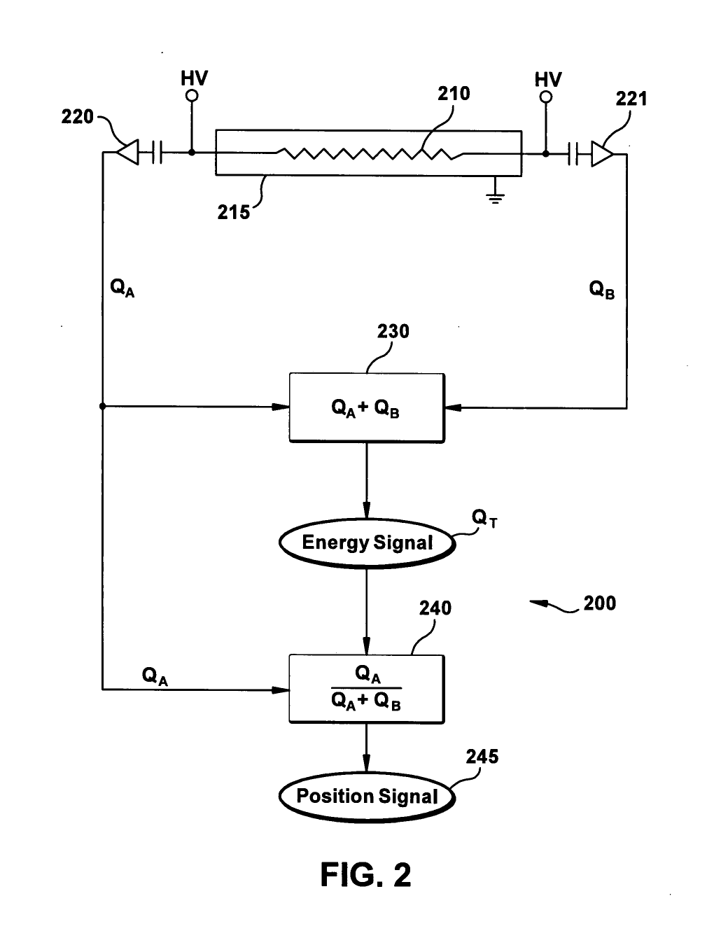

FIG. 2 is a block diagram of a position sensitive radiation detector 200, as embodied by one aspect of the present invention. An anode wire 210, illustratively shown as a resistance, is contained with cathode 215. The anode wire 210 is held at a positive voltage HV, while the cathode 215 is held at ground. The cathode is sealed at both ends, and may be filled with a gas, such as Helium-3 (³He) or BF₃ gas. During use, incident radiation, such as neutrons, interacts with the gas inside the cathode 215 and produces charged particles that ionize the gas atoms and produce electrons. The electrons are drawn to and strike the positive anode wire 210 and create a current pulse that can be detected.

The gas (i.e., ³He or BF₃) in this example is a radiation interacting material, however, other gases could also be used. Other suitable gases used as radiation interacting material can include, but are not limited to, one or combinations of, noble gases, argon, methane, krypton, xenon, ethylene, hydrogen, helium, oxygen, carbon dioxide, and nitrogen. In some instances the use of a stoppilig or quench gas may be desirable. As one example, a polyatomic gas such as methane, can be used for a quench gas. A quench gas is used to prevent parasitic avalanches far from the site of radiation capture. This can become important when used in position sensitive detectors. Solid material could also be used as the radiation interacting material. For example, instead of, or in addition to using an ionizable gas, a solid coating of boron could be applied to the interior walls of the cathode. The boron coating captures incident radiation (e.g., neutrons) and creates ballistic particles that ionize the gas component.

The detector 200, as embodied by the present invention, can use the charge division method to determine the position of the incident radiation event along anode wire 210. Amplifiers 220 and 221 amplify the signal on the anode wire. Amplifier 220 outputs a signal Q_{A}, which is proportional to the amount of charge reaching the left end (as shown in FIG. 2) of anode wire 210. Amplifier 221 outputs a signal Q_{B}, which is proportional to the amount of charge reaching the right end (as shown in FIG. 2) of anode wire 210. The output of the two amplifiers 220 and 221 is summed in block 230 and the result of the summation is an output pulse Q_{T}, where (Q_{T}=Q_{A}+Q_{B}). Q_{T} has an amplitude proportional to the total charge of the incident radiation event. In block 240, a position signal is generated by dividing the portion of charge from one end of the anode wire, in this case Q_{A}, by the total charge (Q_{A}+Q_{B}). Alternatively, the charge Q_{B} could be divided by the total charge (Q_{A}+Q_{B}). The result 245 is an output pulse that indicates the relative position of the incident radiation event along anode wire 210.

Alternative methods for determining the position of an incident radiation event along anode wire 210 could employ the time difference between the relative rise times of pulses at either end of the anode wire 210. For example, preamplifiers could be placed at either end of anode wire 210. A position signal, of an incident radiation event along anode wire 210, can be obtained from the rise time difference between the pulses produced by the two preamplifiers. Other methods for obtaining a position signal are contemplated by the present invention as well.

A few types of radiation detectors have herein been described, but it is to be understood that the present invention could be used with any suitable type of radiation detector. As embodied by the present invention, the anode wire (120, 210) of radiation detectors is preferably made of an amorphous metal alloy.

Amorphous alloys have a variety of potentially useful properties. In particular, they tend to be stronger than crystalline alloys of similar chemical composition. Amorphous metals derive their strength directly from their non-crystalline structure, which does not have any of the defects (such as dislocations) that limit the strength of crystalline alloys. Amorphous metal alloys have been found to be excellent for use as anode wires in radiation detectors.

Amorphous metal wires of small diameter (e.g., 1-150 microns), also referred to as microwires, can be produced by the Taylor-Ulitovsky production process, in which a glass tube and the desired metal are brought into a high-frequency induction field. The metal is melted by the high-frequency induction field, and its heat softens the glass tube, so that a thin metal filled capillary is drawn from the softened glass tube. The metal-filled capillary enters a cooling zone in a superheated state where it is rapidly cooled, such that the desired amorphous structure is obtained. In this process, the alloy melt is rapidly solidified in a softened glass sheath. The presence of the softened glass sheath dampens instability in the alloy melt and promotes the formation of a glass-coated microwire with uniform diameter and a smooth metal-glass interface. Rapid cooling is typically required to obtain amorphous structures. The rate of cooling is not less than 104 degrees C./sec and preferably is 10⁵ to 106 degrees C./sec.

Other methods could also be used to fabricate amorphous metal alloy wires, including, but not limited to, the in-rotating-water melt spinning method disclosed by I. Ohnaka et al., “Production Of Amorphous Filament By In-Rotating-Liquid Spinning Method”, Proceedings Of The 4^{th} International Conference On Rapidly Quenched Metals, Vol. 1, Aug. 24-28, 1981, p. 31-34. Another method is the melt extraction method, disclosed by J. Strom-Olsen, “Fine Fibres By Melt Extraction”, Materials Science And Engineering, Vol. A178, 1994, p. 239-243. These are but a few examples of possible methods for producing amorphous metal alloy wires; other suitable methods could also be employed.

An amorphous metal alloy having improved electrical resistivity, surface finish, corrosion resistance and tensile strength can be obtained by adding additional metal elements to ferromagnetic-based alloys. Typical ferromagnetic-based alloys are iron or cobalt-based alloys. The additional metal elements can be chosen from the transition metal and metalloid elements.

Specifically, the additional metal elements include: Scandium (Sc), Titanium (Ti), Vanadium (V), Chromium (Cr), Manganese (Mn), Iron (Fe), Cobalt (Co), Nickel (Ni), Copper (Cu), Zinc (Zn), Yttrium (Y), Zirconium (Zr), Niobium (Nb), Molybdenum (Mo), Ruthenium (R), Rhodium (Rh), Palladium (Pd), Silver (Ag), Cadmium (Cd), Lanthanum (La), Cerium (Ce), Praseodymium (Pr), Neodymium (Nd), Samarium (Sm), Europium (Eu), Gadolinium (Gd), Terbium (Th), Dysprosium (Dy), Holmium (Ho), Erbium (Er), Thulium (Tm), Ytterbium (Yb), Lutetium (Lu), Haffiium (Hf), Tantalum (Ta), Tungsten (W), Rhenium (Re), Osmium (Os), Iridium (Ir), Platinum (Pt), Gold (Au), Mercury (Hg).

Preferred additional metal elements, which are added to the iron or cobalt-based alloys include: chromium (Cr), manganese (Mn), molybdenum (Mo), and vanadium (V). These are non-ferromagnetic transition metal elements, and are chosen to increase the electronic, magnetic and structural disorder of the amorphous alloy. This increase in disorder is responsible for the increase in electrical resistivity (via increased electronic scattering) and an increase in tensile strength (via reduced formation of shear bands). The chosen additional metal elements can comprise 4-50 atomic percent of the alloy. The preferred additional metal elements can be added alone, or in combination, in the following ranges: chromium in 4-25 atomic percent, manganese in 10-25 atomic percent, molybdenum in 15-30 atomic percent, and/or vanadium in 15-40 atomic percent.

Metalloid elements such as Boron (B), Silicon (Si), Phosphorous (P), Carbon (C), and Germanium (Ge) are known as “glass formers”, and can be used to assist in the formation of the amorphous, glassy metal state. These glass formers can be added in a range of 10-40 atomic percent of the total chemical composition. The preferred elements are boron and silicon. Boron can be present in a range of 10-20 atomic percent and a preferred range is 10-15 atomic percent. Silicon can be present in a range of 5-15 atomic percent, and a preferred range is 10-15 atomic percent. The combination of boron and silicon as glass forming elements is preferred.

In one aspect of the present invention the amorphous metal alloy has a chemical composition represented by the following general formula, by atomic percent: (Co₁₋ₐFeₐ)_{100-b-c-d}Cr_{b}T_{c}X_{d}, where T is at least one element selected from the transition metals, preferably from the group consisting of Mn, Mo, and V, X is at least one element selected from the group consisting of B, Si and P, and a, b, c and d satisfy the formulas of 0≦a≦100, 4≦b≦25, 0≦c≦40, 15≦d≦40, respectively. The alloy structure is fully amorphous and non-crystalline in structure. The fully amorphous structure yields an alloy that can have high tensile strength, greater than 3500 MPa. The electrical resistivity of such an alloy can be greater than 145 μ-cm.

In another aspect of the present invention the amorphous metal alloy has a chemical composition represented by the following general formula, by atomic percent: (Co₁₋ₐFeₐ)_{100-b-c-d}Cr_{b}T_{c}X_{d}, where T is at least one element selected from the transition metals, preferably from the group consisting of Mn, Mo, and V, T is at least one element selected from the group consisting of B, Si and P, and a, b, c and d satisfy the formulas of 5≦a≦25, 4≦b≦25, 20≦c≦40, 15≦d≦30, respectively. The alloy structure is fully amorphous and non-crystalline in structure. The fully amorphous structure yields an alloy that can have high tensile strength, greater than 4500 MPa. The electrical resistivity of such an alloy can be greater than 160 μΩ-cm.

In additional aspects of the present invention, and as representative examples only, the amorphous metal alloy can have the following chemical compositions (in atomic percent): Co_{46.5}Fe₄Cr₄V₂₀Si₁₂B_{13.5}, Co_{46.5}Fe₄Cr₂₄Si₁₂B_{13.5}, Co_{46.5}Fe₄Cr₄Mn₂₀Si₁₂B_{13.5}, Co_{46.5}Fe₄Cr₄Mo₂₀Si₁₂B_{13.5}, Co_{20.5}Fe₄(Ir₂₅Mo₂₅Si₁₂B_{13.5}, Co_{26.5}Fe₄Cr₄V₄₀Si₁₂B_{13.5}, Co_{26.5}Fe₄Cr₄Mn₄₀Si₁₂B_{13.5}, Co₆₈Fe₄Cr₄P₅SiₚB₁₀, Co₆₇Fe₄Cr₄Si₅B₂₀, Co_{46.5}Fe₄Cr₄V₁₀Mn₁₀S₁₂B_{13.5}.

The alloy comprising Co_{46.5}Fe₄Cr₂₄Si₁₂B_{13.5} was found to have good castability. In this context, good castability is defined as the ability to form long, continuous lengths of ribbon or wire. Poor castability is shown when the alloy solidifies into discrete flakes or shards that are not suitable for the application. The melting temperature of this alloy was found to be about 1,050° C. A melting temperature that is too high generally makes it difficult to fully melt the raw materials in an induction heating coil. Induction heating coils are often used in the Taylor-Ulitovsky process of forming glass-covered micro-wires. Also, if the melting point is very high, this may indicate that the alloy is away from what is considered the eutectic material composition, which usually implies poor glass formability. A lower melting point is usually preferred, and should be balanced with the desired material properties of high tensile strength, hardness and high electrical resistivity. The nanohardness of this alloy was found to be about 13.1 GPa. The nanohardness was measured using the Oliver-Pharr technique (G. M Pharr, Materials Science and Engineering, Vol. A253, 1998, p. 151-159). The electrical resistivity of this alloy was found to be about 163 μΩ-cm.

In another aspect of the invention the amorphous metal alloy can have a chemical composition, in atomic percent of: CoₐFe_{b}Cr_{c}Si_{d}Bₑ, where, Co is cobalt, Fe is iron, Cr is chromium, Si is silicon and B is boron, and a, b, c, d, and e represent the atomic percent of Co, Fe, Cr, Si and B respectively, and have the following values: 20≦a≦50, 1≦b≦10, 4≦c≦25, 5≦d≦12, 10≦e≦20, and a+b+c+d+e=100.

In still another aspect of the invention, the amorphous metal alloy can have a chemical composition of: CoₐFe_{b}Cr_{c}Si_{d}BₑT_{f}, where T is at least one element selected from the group comprised of manganese (Mn), molybdenum (Mo) and vanadium (V), and a, b, c, d, e and f represent the atomic percent of Co, Fe, Cr, Si, B and T respectively, and have the following values: 20≦a≦50, 1≦b≦10, 4≦c≦25, 5≦d≦15, 10≦e≦20, 0≦f≦40, and a+b+c+d+e+f=100.

Tensile strength is a very important characteristic for small diameter wires. Radiation detectors often utilize anode wires in the 5-50 micron diameter range. In some applications, the wires may range from 1-100 microns in diameter. It is critical to the accuracy of the detector that these anode wires have a constant diameter over their length. A wire having a constant diameter along its length results in the wire having a constant resistance along its length. A constant resistance is preferred for accurate spatial resolution. Another advantage to high tensile strength is the resistance to plastic deformation. As load is applied to the wire, in the form of constant tensile force, the wire should resist plastic deformation. If the wire plastically deforms, it stretches and the diameter of the wire along its length becomes inconsistent. This results in inconsistent electrical resistance and poor spatial resolution. An advantageous characteristic of amorphous wires is the absence of plastic deformation prior to fracture when loaded. A wire having a tensile strength of 3,500 MPa or greater will, resist deformation, maintain its cross-sectional diameter, be robust in harsh environments and will be able to survive the manufacturing process (particularly for longer anode wires).

Electrical resistance is also a very important characteristic for small diameter wires used in radiation detectors. In position sensitive radiation detectors, the location of an arriving neutron on the anode wire can be determined by the difference in arrival times of electrical pulses at opposite terminals of the anode wire. As the electrical resistance of the anode wire increases, the speed at which the electrical pulses travel along the anode wire decreases. This increases the differential of arrival times at the ends of the anode wire, thereby enabling the detector control electronics to have increased spatial resolution when determining the location of the arriving neutron. A detector fabricated with an anode wire having an electrical resistivity of greater than 145 μΩ-cm, with greater than 160 μΩ-cm preferred, will have excellent spatial resolution.

Amorphous metal alloy wires having high tensile strength and high electrical resistivity have many advantages over crystalline metal alloy wires. The improved tensile strength allows wires with smaller diameters to be used. Wires with smaller diameters have higher resistances. Higher resistance wires are very beneficial in radiation detectors and drastically improve the spatial resolution of the detectors. Some radiation detectors require anode wires up to 4 meters or more in length, and having a wire with high tensile strength to resist breakage and/or plastic deformation is critical in these applications.

Radiation detectors herein described can be used to detect charged particulate radiation (e.g., fast electrons, beta particles, heavy charged particles, alpha particles, or protons) and/or uncharged particles (e.g., electromagnetic radiation or neutrons).

While the invention has been described in terms of various specific embodiments, those skilled in the art will recognize that the invention can be practiced with modification within the spirit and scope of the claims.

What is claimed is:

1. A radiation detector comprising a cathode and an anode, wherein the anode is comprised of an amorphous metal alloy.

2. The radiation detector as defined in claim 1, wherein the amorphous metal alloy has a composition of the formula:
CoₐFe_{b}Cr_{c}Si_{d}Bₑ
wherein, Co is cobalt, Fe is iron, Cr is chromium, Si is silicon and B is boron, and a, b, c, d, and e represent the atomic percent of Co, Fe, Cr, Si and B respectively, and have the following values:
20≦a≦50
1≦b≦10
4≦c≦25
5≦d≦12
10≦e≦20
a+b+c+d+e=100.

3. The radiation detector as defined in claim 2, wherein said amorphous metal alloy exhibits a tensile strength greater than 3500 MPa and an electrical resistivity greater than 145 μΩ-cm.

4. The radiation detector as defined in claim 2, said composition further comprising element group T, where T is at least one element selected from the group comprised of manganese (Mn), molybdenum (Mo) and vanadium (V), said amorphous metal alloy having a composition of the formula:
CoₐFe_{b}Cr_{c}Si_{d}BₑT_{f}
wherein, f, in atomic percent, has the following value:
10≦f≦40, and
a+b+c+d+e+f=100.

5. The radiation detector as defined in claim 4, wherein said amorphous metal alloy exhibits a tensile strength greater than 4500 MPa, and an electrical resistivity greater than 160 μΩ-cm.

6. The radiation detector as defined in claim 4, wherein said radiation detector comprises:
a cathode comprising first and second opposing ends, said cathode enclosing a volume, and said volume being filled with an ionizable gas;
said anode extending within said cathode from said first opposing end to said second opposing end, and wherein said anode is electrically insulated from said cathode, and
wherein said radiation detector is configured for detecting neutrons.

7. The radiation detector as defined in claim 1, further comprising:
signal sensing means coupled to said anode, said signal sensing means comprising a first signal sensing component and a second signal sensing component, said signal sensing means for detecting an incident radiation event;
said anode having a first end and a second end opposing said first end; said first signal sensing component coupled to said first end, and said second signal sensing component coupled to said second end;
wherein, a location of said incident radiation event along said anode can be determined by analyzing a time differential between a first signal received by said first signal sensing component and a second signal received by said second signal sensing component.

8. The radiation detector as defined in claim 1, further comprising:
charge sensing means coupled to said anode, said charge sensing means comprising a first charge sensing component and a second charge sensing component, said charge sensing means for detecting an incident radiation event;
said anode having a first end and a second end opposing said first end;
said first charge sensing component coupled to said first end, and said second charge sensing component coupled to said second end;
wherein, a location of said incident radiation event along said anode can be determined by dividing an amount of charge output by either said first charge sensing component or said second charge sensing component, by the summation of charge obtained by adding the charge output by both said first and second charge sensing components.

9. A radiation detector comprising:
a cathode assembly, said cathode assembly comprising a main portion, a first end and a second end, wherein said first end opposes said second end, and wherein said cathode assembly defines a volume;
a radiation interacting material contained within said volume defined by said cathode assembly;
an anode extending within said cathode assembly from said first end to said second end, and wherein said anode is comprised of an amorphous metal alloy.

10. The radiation detector as defined in claim 9, wherein said amorphous metal alloy comprises:
at least one or combinations of, cobalt (Co) and iron (Fe);
chromium (Cr);
silicon (Si);
boron (B); and
at least one or combinations of, manganese (Mn), molybdenum (Mo) and vanadium (V).

11. The radiation detector as defined in claim 9, wherein the amorphous metal alloy has a chemical composition represented by the following general formula, by atomic percent:
(Co₁₋ₐFeₐ)_{100-b-c-d}Cr_{b}T_{c}X_{d},
wherein, T is at least one element selected from the group consisting of Mn, Mo, and V; X is at least one element selected from the group consisting of B, Si and P, and a, b, c and d satisfy the formulas of:
0≦a≦100,
4≦b≦25,
0≦c≦40,
15≦d≦35.

12. The radiation detector as defined in claim 11, wherein said amorphous metal alloy exhibits a tensile strength greater than 3500 MPa, and an electrical resistivity greater than 145 μΩ-cm.

13. The radiation detector as defined in claim 11, wherein:
0≦a≦10,
4≦b≦24,
20≦c≦40,
15≦d≦35, and
said amorphous metal alloy exhibits a tensile strength greater than 4500 MPa, and an electrical resistivity greater than 160 μΩ-cm.

14. The radiation detector as defined in claim 9, wherein:
said radiation interacting material comprises an ionizable gas, said ionizable gas contained within said cathode assembly;
said anode comprising at least one anode wire; and
circuit means connected to said at least one anode wire, said circuit means for determining the location of an incident radiation event along said at least one anode wire.

15. The radiation detector as defined in claim 9, said amorphous metal alloy having the composition: Co_{46.5}Fe₄Cr₂₄Si₁₂B_{13.5}, and wherein said amorphous metal alloy exhibits a tensile strength greater than 4500 MPa, and an electrical resistivity greater than 160 μΩ-cm.

16. The radiation detector as defined in claim 9, said amorphous metal alloy having the composition: Co_{46.5}Fe₄Cr₄Mn₂₀Si₁₂B_{13.5}, and wherein said amorphous metal alloy exhibits a tensile strength greater than 4500 MPa, and an electrical resistivity greater than 160 μΩ-cm.

17. The radiation detector as defined in claim 9, said amorphous metal alloy having the composition: Co_{46.5}Fe₄Cr₄V₂₀Si₁₂B_{13.5}, and wherein said amorphous metal alloy exhibits a tensile strength greater than 4500 MPa.

18. The radiation detector as defined in claim 9, said amorphous metal alloy having the composition: Co_{26.5}Fe₄Cr₄V₄₀Si₂B_{13.5}, and wherein said amorphous metal alloy exhibits a tensile strength greater than 4500 MPa.

19. The radiation detector as defined in claim 9, further comprising:
signal sensing means coupled to said anode, said signal sensing means comprising a first signal sensing component and a second signal sensing component, said signal sensing means for detecting an incident radiation event;
said anode having a first end and a second end opposing said first end; said first signal sensing component coupled to said first end, and said second signal sensing component coupled to said second end;
wherein, a location of said incident radiation event along said anode can be determined by analyzing a time differential between a first signal received by said first signal sensing component and a second signal received by said second signal sensing component.

20. The radiation detector as defined in claim 9, further comprising:
charge sensing means coupled to said anode, said charge sensing means comprising a first charge sensing component and a second charge sensing component, said charge sensing means for detecting an incident radiation event;
said anode having a first end and a second end opposing said first end; said first charge sensing component coupled to said first end, and said second charge sensing component coupled to said second end;
wherein, a location of said incident radiation event along said anode can be determined by dividing an amount of charge output by either said first charge sensing component or said second charge sensing component, by the summation of charge obtained by adding the charge output by both said first and second charge sensing components.
